(19) United States
(12) Patent Application Publication
(10) Pub. No.: US 2026/0155421 A1
(43) Pub. Date: Jun. 4, 2026

(54) CLAMPING APPARATUS FOR FUEL CELL STACK

(71) Applicant: Industrial Technology Research Institute, Hsinchu (TW)

(72) Inventors: HSIEN-CHIEN CHEN, New Taipei City (TW); CHIH-HAO WANG, Kaohsiung City (TW); SUNG-CHUN CHANG, Hsinchu City (TW); CHIEN-MING LAI, Hsinchu County (TW); LI-DUAN TSAI, Hsinchu City (TW)

(21) Appl. No.: 19/214,714

(22) Filed: May 21, 2025

(30) Foreign Application Priority Data
Nov. 29, 2024 (TW) 113146250

(51) Int. Cl. H01M 8/248

(52) U.S. Cl. CPC H01M 8/248

(57) ABSTRACT

The present disclosure provides a clamping apparatus for a fuel cell stack. The fuel cell stack has a top surface and a bottom surface that are opposite and parallel to each other, the top surface and the bottom surface are parallel to an X-Y plane fabricated by an X-axis and a Y-axis. A first surface and a second surface, opposite and parallel to each other, are between the top surface and the bottom surface. The first surface and the second surface are parallel to an X-Z plane fabricated by the X-axis and a Z-axis. The X-axis, the Y-axis and the Z-axis are perpendicular to each other. The clamping apparatus comprises at least one first pressing part, at least one second pressing part, at least one first fastening part, at least one second fastening part, and a plurality of connection assemblies.

### CROSS REFERENCE TO RELATED APPLICATION

This application claims the benefits of Taiwan application Serial No. 113146250, filed on Nov. 29, 2024, the disclosures of which are incorporated by references herein in its entirety.

### TECHNICAL FIELD

The present disclosure generally relates to a field with fuel cell technologies, more particularly to a clamping apparatus for a fuel cell stack.

### BACKGROUND

A fuel cell stack is formed by stacking a plurality of fuel cells and then securing and sealing them. The fields of applications are very broad, such as power sources for electric vehicles, ships, buildings, factories, etc. Presently, the main methods for securing fuel cell stacks are bolt-type and strap-type.

Although the bolt-type assembly is relatively easy, it consumes more processing time and easily happens errors due to the amount of manual force applied and the accuracy of the torque wrench, etc., which can affect the stability of the locking process.

Additionally, the protruding threaded rod will increase the gap between the fuel cell stack and the casing, so as to let assembling the casing be difficult for stabilization. When used in automobiles, the nuts may easily loosen during driving, resulting in insufficient fastening force for the fuel cell stack, which is able to lead to performance degradation or leakage.

Compared with the bolt-type, the strap-type is relatively easier, since a larger contact area is supplied on the end plates of the fuel cell stack, resulting in a more uniform pressure distribution. However, the strap-type is easily happening deformation during the assembly process, and requires laser welding equipment. Hence, the cost is higher.

Accordingly, how to develop a “clamping apparatus for fuel cell stacks” that reduces the time consumed in the locking process, prevents uneven force application during the tightening process, and allows for fast assembly design and reduced engineering time without affecting locking stability, thereby further improving the locking performance, is an issue to people skilled in the art.

### SUMMARY

For an embodiment, the present disclosure provides a clamping apparatus for a fuel cell stack. The fuel cell stack has a top surface and a bottom surface that are opposite and parallel to each other, the top surface and the bottom surface are parallel to an X-Y plane fabricated by an X-axis and a Y-axis. A first surface and a second surface, opposite and parallel to each other, are between the top surface and the bottom surface. The first surface and the second surface are parallel to an X-Z plane fabricated by the X-axis and a Z-axis. The X-axis, the Y-axis and the Z-axis are perpendicular to each other. The clamping apparatus comprises:
at least one first pressing part, which two opposite sides have a plurality of first raised portions and a plurality of second raised portions respectively, each of the first raised portions has a first hole that is co-axially parallel to the X-axis and penetrates through the first raised portion, each of the second raised portions has a second hole that is co-axially parallel to the X-axis and penetrates through the second raised portion, the first pressing part is disposed on the top surface of the fuel cell stack;
at least one second pressing part, which two opposite sides have a plurality of third raised portions and a plurality of fourth raised portions respectively, each of the third raised portions has a third hole that is co-axially parallel to the X-axis and penetrates through the third raised portion, each of the fourth raised portions has a fourth hole that is co-axially parallel to the X-axis and penetrates through the fourth raised portion, the second pressing part is disposed on the bottom surface of the fuel cell stack;
at least one first fastening part, which is parallel to the Z-axis and has two opposite ends, a first end and a second end, the first end has at least one fifth hole that is parallel to the X-axis and penetrates through the first end, the second end has at least one sixth hole that is parallel to the X-axis and penetrates through the second end, the first fastening part is disposed on the first surface of the fuel cell stack, the first end is embedded between the two first raised portions, each of the fifth holes and each of the first holes are co-axially formed a first connection channel, the second end is embedded between the two third raised portions, each of the sixth holes and each of the third holes are co-axially formed a second connection channel;
at least one second fastening part, which is parallel to the Z-axis and has two opposite ends, a third end and a fourth end, the third end has at least one seventh hole that is parallel to the X-axis and penetrates through the third end, the fourth end has at least one eighth hole that is parallel to the X-axis and penetrates through the fourth end, the second fastening part is disposed on the second surface of the fuel cell stack, the third end is embedded between the two second raised portions, each of the seventh holes and each of the second holes are co-axially formed a third connection channel, the fourth end is embedded between the two fourth raised portions, each of the eighth holes and each of the fourth holes are co-axially formed a fourth connection channel; and
a plurality of connection assemblies, which are disposed at the first connection channel, the second connection channel, the third connection channel, and the fourth connection channel respectively.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 illustrates a schematic view of an assembled structure of an embodiment of the disclosure;

FIG. 2 illustrates a schematic view of an exploded structure of the embodiment in FIG. 1;

FIG. 3 illustrates a schematic structural view of a first pressing part with an elastic member of the embodiment in FIG. 1;

FIG. 4 illustrates a schematic exploded structural view of the first pressing part and a second pressing part with a first fastening part and a second fastening part of the embodiment in FIG. 1;

FIG. 5 illustrates a schematic assembled structural view of the first pressing part and the second pressing part with the first fastening part and the second fastening part of the embodiment in FIG. 1;

FIG. 6 illustrates a schematic structural view of the embodiment in FIG. 1 penetrating through connection assemblies of the present disclosure;

FIG. 7 illustrates a front structural view of the embodiment in FIG. 1;

FIG. 8 illustrates a schematic structural view of an A-A cross-section in FIG. 7;

FIG. 9 to FIG. 12 illustrate schematic assembled structural views of three different embodiments of the present disclosure;

FIG. 13 illustrates a schematic structural view of the embodiment in FIG. 1 with different types of the first fastening part and the second fastening part;

FIG. 14A to FIG. 14C illustrates schematic structural views of different embodiments of the first fastening part of the present disclosure; and

FIG. 15A to FIG. 15B illustrate schematic structural view of different embodiments of a bolt of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The terms “including”, “comprising”, “having” and the like mentioned in this disclosure are all open terms; i.e., implying only “including but not limited to”.

In the description of embodiments, when terms such as “first”, “second”, “third”, “fourth” etc. are used to describe elements, they are only used to distinguish these elements from each other, but not limit order or importance of any of these elements.

In the descriptions of various embodiments, the so-called “coupling” or “connection” may refer to two or a plurality of components making physical or electrical contact directly or indirectly with each other, or refer to the mutual operation or action of two or a plurality of elements.

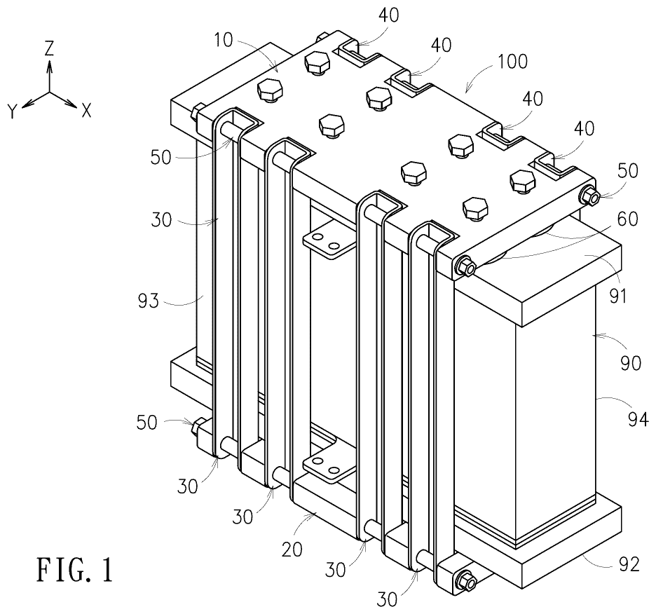

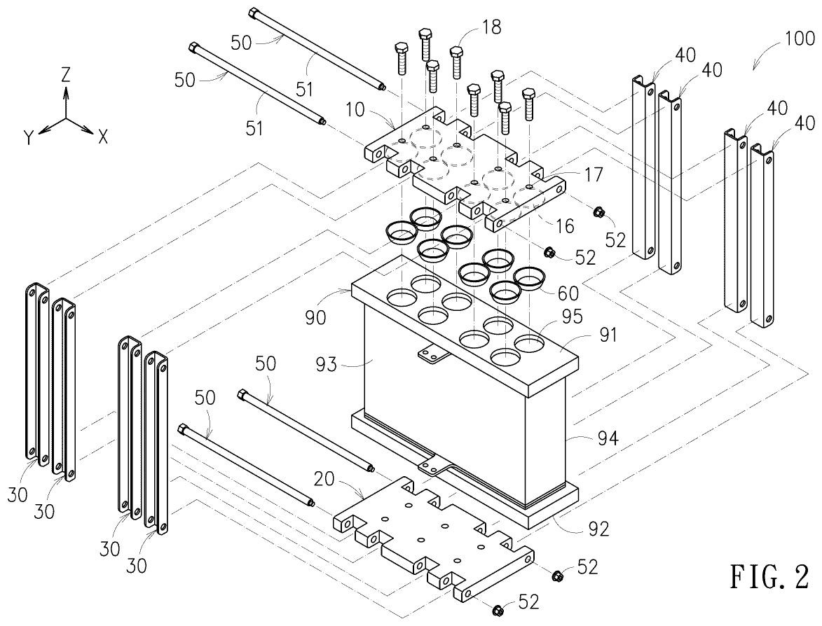

Please refer to FIG. 1 and FIG. 2, which illustrates schematic view of a clamping apparatus 100 of a fuel cell stack 90 provided by the present disclosure. The fuel cell stack 90 has a top surface 91 and a bottom surface 92 which are opposite and parallel to each other. The top surface 91 and the bottom surface 92 are parallel to an X-Y plane fabricated by an X-axis and a Y-axis. A first surface 93 and a second surface 94, opposite and parallel to each other, are between the top surface 91 and the bottom surface 92. The first surface 93 and the second surface 94 are parallel to an X-Z plane fabricated by the X-axis and a Z-axis, and the X-axis, the Y-axis and the Z-axis are perpendicular to each other.

It is to be noted that the fuel cell stack 90 can take various forms, and FIG. 1 and FIG. 2 only illustrate one embodiment, which is not limited thereto.

The clamping apparatus 100 includes a first pressing part 10, a second pressing part 20, four first fastening parts 30, four second fastening parts 40, and four connection assemblies 50. The materials of the first pressing part 10, the second pressing part 20, the first fastening part 30, and the second fastening part 40 can be one of steel, aluminum, plastic steel, and plastic.

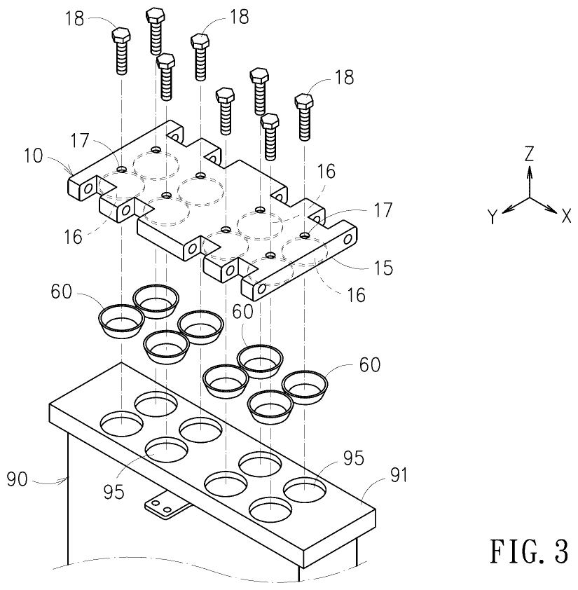

With reference to FIG. 2 and FIG. 3, the first pressing part 10 is disposed on the top surface 91 of the fuel cell stack 90. A bottom surface 15 of the first pressing part 10 and the top surface 91 of the fuel cell stack 90 are faced to each other. In the embodiment, a plurality of first recess portions 95 are disposed on the top surface 91 of the fuel cell stack 90. A plurality of second recess portions 16 are disposed on the bottom surface 15 of the first pressing part 10, wherein the second recess portion 16 corresponds to the first recess portion 95. In addition, the first pressing part 10 is disposed on the top surface 91 of the fuel cell stack 90. A plurality of elastic members 60 are disposed between the first recess portions 95 and the second recess portions 16, wherein the elastic member 60 is a disc-shaped spring, but it should not be a limitation. Further, the elastic member 60 can be instead of cushioning pad made of rubber, silicone, or foam metal. That is, the elastic member 60 can be any object having elastic flexibility that is parallel to the Z-axis.

The number of elastic members 60 is not limited, as long as they can be evenly distributed between the first pressing part 10 and the fuel cell stack 90. For example, there are eight elastic members 60 shown in FIG. 3, but this is not restrictive.

A screw hole 17 is disposed at the first pressing part 10 and corresponds to the second recess portion 16. The screw hole 17 is parallel to the Z-axis and penetrates through the first pressing part 10. A bolt 18 is disposed in the screw hole 17 and parallel to the Z-axis, and the bolt 18 is screwed into the screw hole 17 from outside (a top portion of the first pressing part 10 as shown in FIG. 2 and FIG. 3) of the first pressing part 10 and penetrates through the elastic member 60 to the first recess portion 95 that corresponds to the elastic member 60. Therefore, the elastic member 60 is positioned between the first pressing part 10 and the fuel cell stack 90, as shown in FIG. 1.

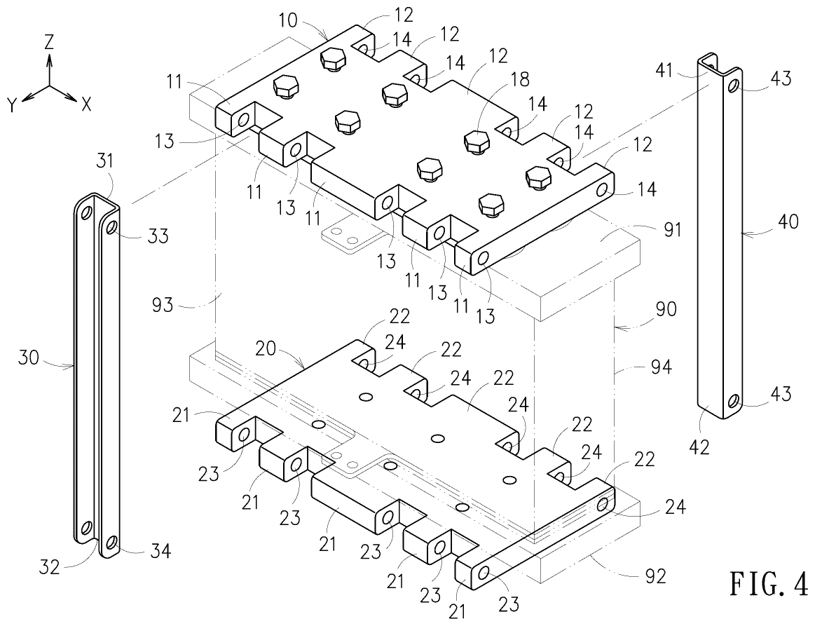

Referring to FIG. 2 and FIG. 4, the two opposite sides of the first pressing part 10 have a plurality of first raised portions 11 and a plurality of second raised portions 12 respectively. Each of the first raised portions 11 has a first hole 13 that is co-axially parallel to the X-axis and penetrates through the first raised portion 11, and each of the second raised portions 12 has a second hole 14 that is co-axially parallel to the X-axis and penetrates through the second raised portion 12.

The two opposite sides of the second pressing part 20 have a plurality of third raised portions 21 and a plurality of fourth raised portions 22 respectively. Each of the third raised portions 21 has a third hole 23 that is co-axially parallel to the X-axis and penetrates through the third raised portion 21, and each of the fourth raised portions 22 has a fourth hole 24 that is co-axially parallel to the X-axis and penetrates through the fourth raised portion 22. The second pressing part 20 is disposed on the bottom surface 92 of the fuel cell stack 90.

The first fastening part 30 is parallel to the Z-axis and has two opposite ends, a first end 31 and a second end 32. The first end 31 has a fifth hole 33 that is parallel to the X-axis and penetrates through the first end 31, and the second end 32 has a sixth hole 34 that is parallel to the X-axis and penetrates through the second end 32.

The second fastening part 40 is parallel to the Z-axis and has two opposite ends, a third end 41 and a fourth end 42, The third end 41 has a seventh hole 43 that is parallel to the X-axis and penetrates through the third end 41, and the fourth end 42 has an eighth hole 44 that is parallel to the X-axis and penetrates through the fourth end 42.

For the embodiment, the shape of the first pressing part 10 is the same as the shape of the second pressing part 20, and the shape of the first fastening part 30 is the same as the shape of the second fastening part 40. The cross-sections of the first fastening part 30 and the second fastening part 40 are shaped as the letter n, and the two cross-sections are parallel to the X-Y plane, but it is not limited thereto.

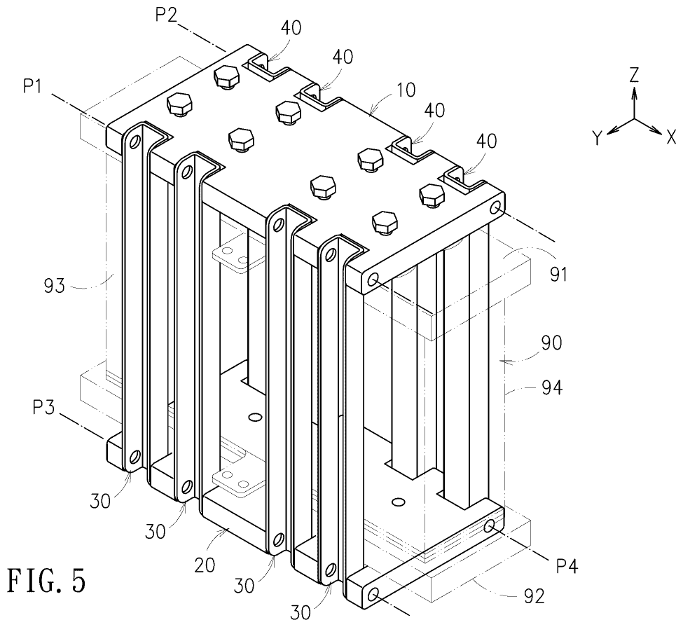

In regard to FIG. 4 and FIG. 5, the first fastening part 30 is disposed on the first surface 93 of the fuel cell stack 90. The first end 31 is embedded between the two first raised portions 11. Each of the fifth holes 33 and each of the first holes 13 are co-axially formed a first connection channel P1, the second end 32 is embedded between the two third raised portions 21, and each of the sixth holes 34 and each of the third holes 23 are co-axially formed a second connection channel P2.

The second fastening part 40 is disposed on the second surface 94 of the fuel cell stack 90. The third end 41 is embedded between the two second raised portions 12, each of the seventh holes 43 and each of the second holes 14 are co-axially formed a third connection channel P3, and the fourth end 42 is embedded between the two fourth raised portions 22, each of the eighth holes 44 and each of the fourth holes 24 are co-axially formed a fourth connection channel P4.

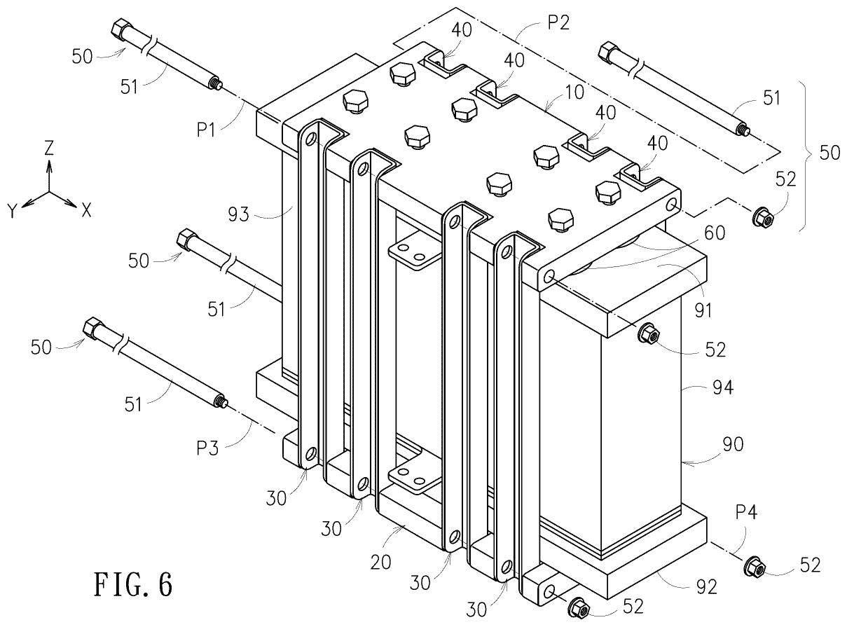

As to FIG. 5 and FIG. 6, the first connection channel P1, the second connection channel P2, the third connection channel P3, and the fourth connection channel P4 are all parallel to the X-axis. The first connection channel P1, the second connection channel P2, the third connection channel P3, and the fourth connection channel P4 are disposed a connection assembly 50 respectively.

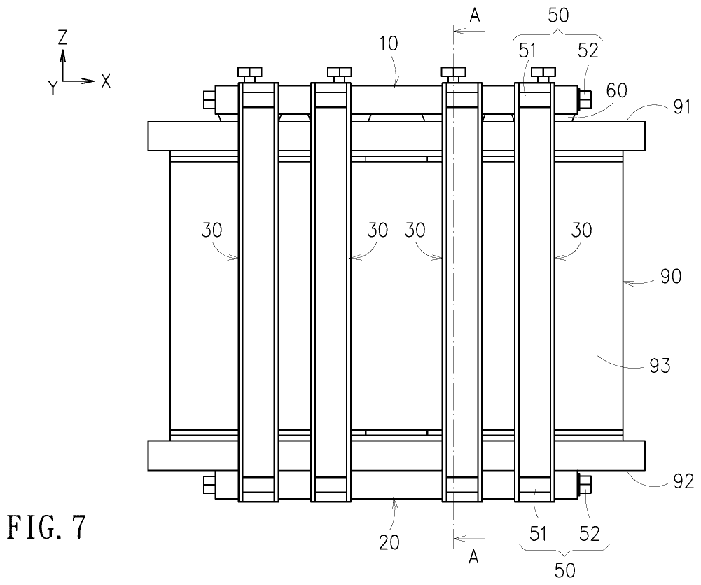

The connection assembly is constructed by a connection element 51 and a nut 52. As for the embodiment, the first connection channel P1, the second connection channel P2, the third connection channel P3, and the fourth connection channel P4 are fastened by the connection element 51 and the nut 52 respectively. In such way, the combined appearance structures shown in FIG. 1 and FIG. 7 are achieved.

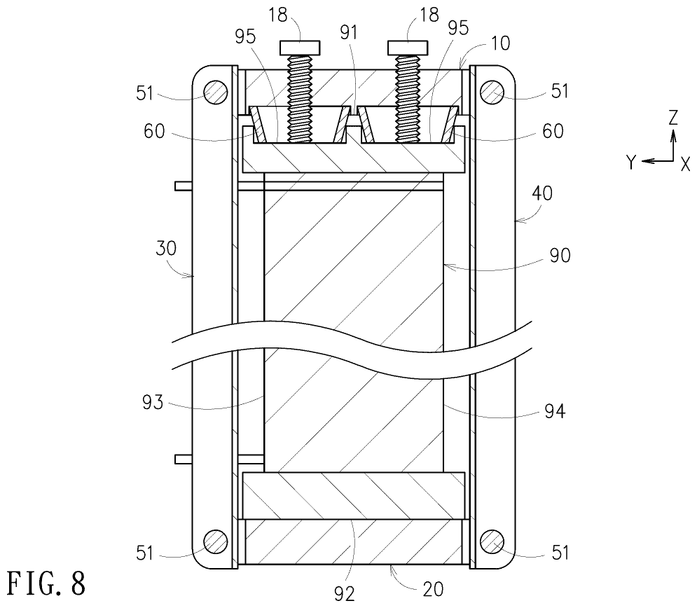

In relation to FIG. 1, FIG. 7 and FIG. 8, the first pressing part 10, the second pressing part 20, the first fastening part 30, and the second fastening part 40 are disposed on the top surface 91, the bottom surface 92, the first surface 93, and the second surface 94 of the fuel cell stack 90 respectively, and the plural parts and the plural surfaces are fastened by the connection elements 51 and the nuts 52 of the connection assemblies 50.

The bolt 18 is parallel to the Z-axis and screwed into the elastic member 60 from the top surface of the first pressing part 10, then to the first recess portion 95 that corresponds to the elastic member 60. The elastic member 60 is located between the first pressing part 10 and the fuel cell stack 90. A distance between the first pressing part 10 and the top surface 91 can be adjusted via altering the depth of the bolt 18 screwing into the first pressing part 10. The elastic member 60 can maintain a stable balance of forces parallel to the X-axis direction and enhance the fuel cell stack 90 with better uniform locking and pressure distribution effects.

With respect to FIG. 6, as it can be seen, the differences between the present disclosure and the tightening device of a prior fuel cell stack are described as following. In the present disclosure, the first connection channel P1, the second connection channel P2, the third connection channel P3, and the fourth connection channel P4 can be respectively formed between the first pressing part 10 and the first fastening part 30, the first pressing part 10 and the second fastening part 40, the second pressing part 20 and the first fastening part 30, and the second pressing part 20 and the second fastening part 40. By allowing a single connection element 51 to pass through each channel and screw into the nut 52, assembly can be completed quickly and easily. Such structure creates a clamping and tightening effect on the top surface 91, the bottom surface 92, the first surface 93, and the second surface 94 of the fuel cell stack 90. Similarly, during disassembly, loosening the nut 52 and removing the connection element 51 allows for rapid and straightforward disassembly.

If the elastic member 60 is installed between the first pressing part 10 and the fuel cell stack 90, it is able to provide external vibration buffering and improve the pressure uniformity of the fuel cell stack 90. In other words, the user can decide whether the elastic member 60 is disposed based on actual needs.

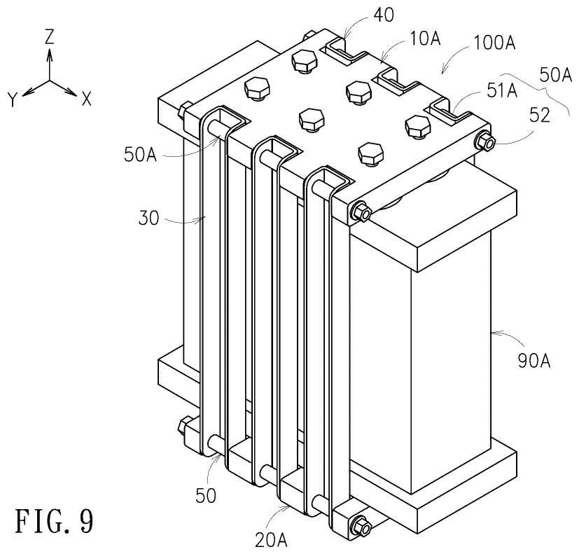

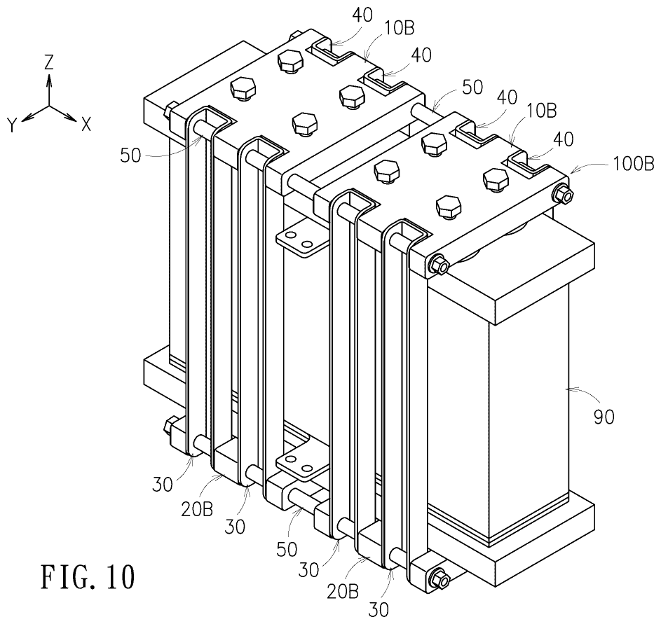

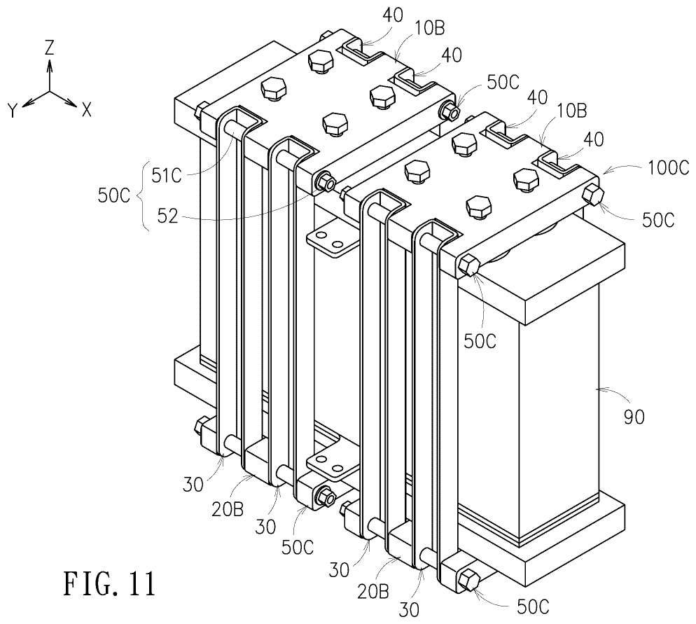

According to FIG. 9, FIG. 10 and FIG. 11, which illustrate assembled structures of other three different embodiments of the present disclosure.

Referring to FIG. 9, the size, parallel to the X-axis, of the fuel cell stack 90A is smaller compared with the embodiment shown in FIG. 1. The first pressing part 10A and the second pressing part 20A of a clamping apparatus 100A are comparatively smaller in the aspect of length, wherein the first pressing part 10A and the second pressing part 20A are parallel to the X-axis. The connection assembly 50A includes a connection element 51A and a nut 52. The length of the connection element 51A parallel to the X-axis is comparatively smaller, and only the three first fastening parts 30 and the three second fastening parts 40 are applied.

Please refer to FIG. 10, the sizes of the fuel cell stack 90 are the same as the fuel cell stack illustrated in FIG. 1. A clamping apparatus 100B has two first pressing parts 10B and two second pressing parts 20B. The sizes of the first pressing part 10B and the second pressing part 20B are comparatively smaller in the aspect of length, wherein the first pressing part 10B and the second pressing part 20B are parallel to the X-axis. The numbers of the first fastening part 30 and the second fastening part 40 are still four, but there are four connection assemblies 50 to be applied.

As for FIG. 11, a clamping apparatus 100C adopts the first pressing part 10B and the second pressing part 20B that are the same as the illustrations in FIG. 10. The numbers of the first fastening part 30 and the second fastening part 40 are four as well, but there are eight connection assemblies 50C to be applied. The connection assembly 50C includes a connection element 51C and a nut 52. Compared to FIG. 1 or FIG. 10, the connection element 51C in FIG. 11 is smaller in the aspect of the connection element 51C being parallel to the X-axis.

Considering FIG. 1, FIG. 9 to FIG. 11, the first pressing part 10, the second pressing part 20, the first pressing part 10A, the second pressing part 20A, or the first pressing part 10B and the second pressing part 20B in FIG. 10 and FIG. 11 are cooperated with each other to be suitable for the fuel cell stacks of different sizes. Similarly, the connection elements with different lengths, such as 51, 51A, or 51C, can be used as needed.

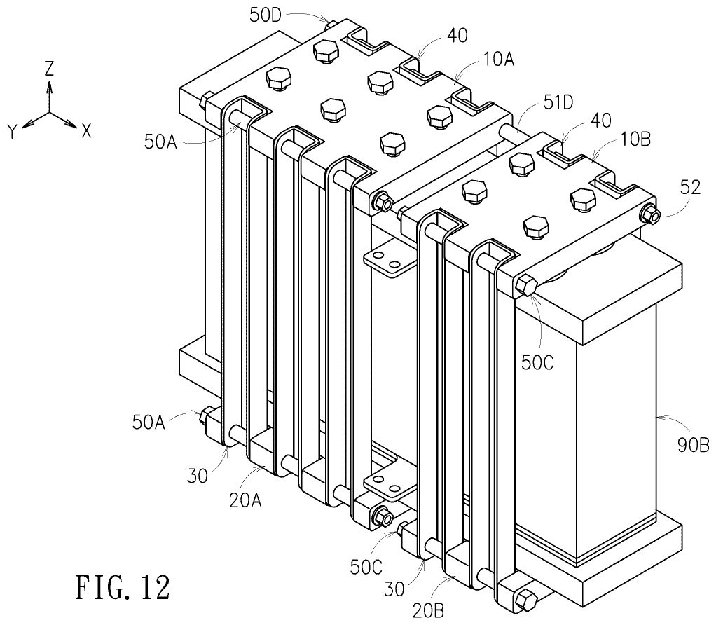

As shown in FIG. 12, a fuel cell stack 90B is greater than the illustration in FIG. 1 in the aspect of length, wherein the fuel cell stack 90B is parallel to the X-axis. The embodiment adopts one first pressing part 10A and one second pressing part 20A to cooperate with one first pressing part 10B and one second pressing part 20B. Totally, there are five first fastening parts 30 and five second fastening parts 40 to be used. In addition to the connection assemblies 50A, 50C, there is another connection assembly 50D, which includes a connection element 51D and a nut 52. The connection element 51D is greater in length and parallel to the X-axis, further that, it penetrates through the first pressing parts 10A, 10B.

Examining the embodiments shown in FIG. 1 and FIG. 9 to FIG. 12, although their configurations differ slightly, they all share a common characteristic. That is, taking FIG. 1 as an example, a single connecting assembly 50 can link the first pressing part 10 to the first fastening part 30, the first pressing part 10 to the second fastening part 40, the second pressing part 20 to the first fastening part 30, or the second pressing part 20 to the second fastening part 40. It could be seen that assembly and disassembly are both very simple and quick.

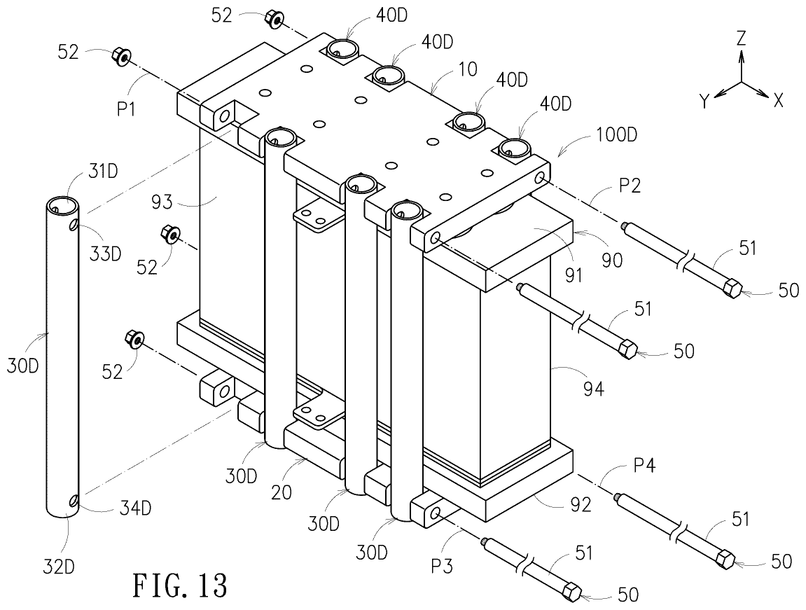

In accordance with the illustration in FIG. 13, a clamping apparatus 100D includes one first pressing part 10, one second pressing part 20, four first fastening part 30D, four second fastening part 40D, and four connection assemblies 50.

Compared with the embodiment in FIG. 1, the first fastening part 30D and the second fastening part 40D of the locking device 100D are cylindrical.

The first fastening part 30D is parallel to the Z-axis and has two opposite ends, a first end 31D and a second end 32D. The first end 31D has a fifth hole 33D, which is parallel the X-axis and penetrates through the first end 31D. The second end 32D has a sixth hole 34D, which is parallel the X-axis and penetrates through the second end 32D. The shape of the second fastening part 40D is the same as the first fastening part 30D, and it may not be described any further hereinafter.

Even though this embodiment uses the first fastening part 30D and the second fastening part 40D with different shapes, the connections between the first pressing part 10 and the first fastening part 30D, the first pressing part 10 and the second fastening part 40D, the second pressing part 20 and the first fastening part 30D, and the second pressing part 20 and the second fastening part 40D can still be secured using only one single connection element 51 and nut 52 for each connection. Hence, assembly and disassembly remain very simple and quick, and such design provides a clamping and tightening effect on the top surface 91, the bottom surface 92, the first surface 93, and the second surface 94 of the fuel cell stack 90.

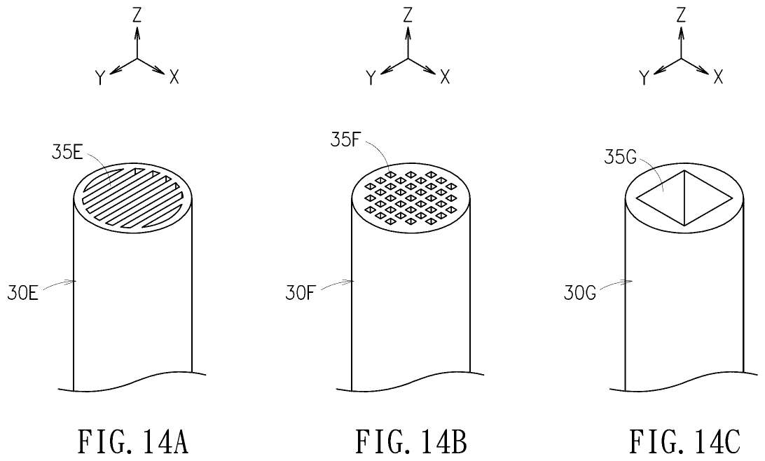

In view of FIG. 14A to FIG. 14C, which illustrate plural first fastening parts 30E, 30F and 30G with different cross-sections. The first fastening part 30E in FIG. 14A has a plurality of elongated slots 35E that are parallel to the Y-axis and to each other, with each slot running through the first fastening part 30E that is parallel to the Z-axis. The first fastening part 30F shown in FIG. 14B has a plurality of square holes 35F that are parallel to the Z-axis and run through the first fastening part 30F. The first fastening 30G of FIG. 14C has a larger square hole 35G that is parallel to the Z-axis and runs through the first fastening 30G.

The shapes of the first fastening parts 30 and 30D˜30G shown in FIG. 1, FIG. 13, and FIG. 14A˜14C are different but interchangeable. Additionally, the shape of the second fastening part 40 in FIG. 1 can be the same as or different from the first fastening parts 30E˜30G shown in FIG. 14A˜14C. In other words, the shapes of the cross-sections of the first and second fastening parts in this disclosure are not limited and can take regular or irregular geometric forms, wherein the cross-sections are parallel to the X-Y plane.

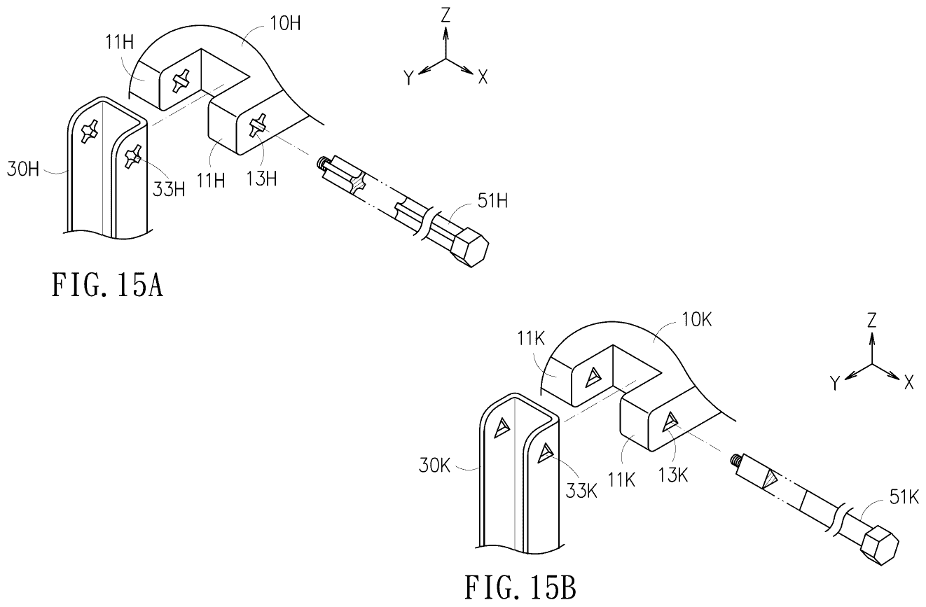

Please refer to FIG. 15A and FIG. 15B, which illustrate a connection element 51H and a connection element 51K with different structures.

The connection element 51H shown in FIG. 15A has a cross-shaped cross-section in the Y-Z plane. The first hole 13H of the first raised portion 11H of the first pressing part 10H is also cross-shaped, as is the fifth hole 33H of the first fastening part 30H. When the connection element 51H is through the first hole 13H and the fifth hole 33H, it prevents the connection element 51H from rotating, wherein the connection element 51H is parallel to the X-axis.

For the same reason, as shown in FIG. 15B, the cross-section of the connection element 51K in the Y-Z plane, the first hole 13K of the first raised portion 11K of the first pressing part 10K, and the fifth hole 33K of the first fastening part 30K are all shaped as triangular.

The first pressing part 10 and the second pressing part 20 shown in FIG. 2 can be replaced with the first pressing parts 10H, 10K shown in FIG. 15A and FIG. 15B. The first fastening part 30 and the second fastening part 40 shown in FIG. 2 can be replaced with the first fastening parts 30H, 30K shown in FIG. 15A and FIG. 15B. The bolt 51 shown in FIG. 2 can be instead of the connection elements 51H, 51K shown in FIG. 15A and FIG. 15B.

FIG. 6 and FIG. 15A to FIG. 15B show the connection elements 51, 51H, 51K with different cross-sectional structures, illustrating that the type of connection assemblies used in this disclosure is not limited. As long as holes are provided in the first pressing part, the second pressing part, the first fastening part, and the second fastening part, which are shaped to allow the bolt to pass through, the configuration is thus suitable. The connection elements 51, 51A, 51C, 51D, 51H and 51K may be blots, screws or other similar fixing components.

As a conclusion, the clamping apparatus for the fuel cell stack provided by the present disclosure allows the formation of a first connection channel between the first pressing part and the first fastening part, a second connection channel between the first pressing part and the second fastening part, a third connection channel between the second pressing part and the first fastening part, and a fourth connection channel between the second pressing part and the second fastening part. A single connection assembly can be used to secure these connections, making assembly and disassembly both very simple and fast.

Additionally, an elastic member can be disposed between the first pressing part and the fuel cell stack to perform pressure equalization and fixation in the vertical stack direction using a tightening tool. Such arrangements are able to reduce the issue of uneven pressure caused by localized stress concentration at the edge of the top surface of the fuel cell stack, thereby improving the performance and stability of the fuel cell stack.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A clamping apparatus for a fuel cell stack, the fuel cell stack having a top surface and a bottom surface that are opposite and parallel to each other, the top surface and the bottom surface being parallel to an X-Y plane fabricated by an X-axis and a Y-axis, a first surface and a second surface, opposite and parallel to each other, being between the top surface and the bottom surface, the first surface and the second surface being parallel to an X-Z plane fabricated by the X-axis and a Z-axis, the X-axis, the Y-axis and the Z-axis being perpendicular to each other, the clamping apparatus comprising:
at least one first pressing part, which two opposite sides have a plurality of first raised portions and a plurality of second raised portions respectively, each of the first raised portions having a first hole that is co-axially parallel to the X-axis and penetrates through the first raised portion, each of the second raised portions having a second hole that is co-axially parallel to the X-axis and penetrates through the second raised portion, the first pressing part being disposed on the top surface of the fuel cell stack;
at least one second pressing part, which two opposite sides have a plurality of third raised portions and a plurality of fourth raised portions respectively, each of the third raised portions having a third hole that is co-axially parallel to the X-axis and penetrates through the third raised portion, each of the fourth raised portions having a fourth hole that is co-axially parallel to the X-axis and penetrates through the fourth raised portion, the second pressing part being disposed on the bottom surface of the fuel cell stack;
at least one first fastening part, which is parallel to the Z-axis and has two opposite ends, a first end and a second end, the first end having at least one fifth hole that is parallel to the X-axis and penetrates through the first end, the second end having at least one sixth hole that is parallel to the X-axis and penetrates through the second end, the first fastening part being disposed on the first surface of the fuel cell stack, the first end being embedded between the two first raised portions, each of the fifth holes and each of the first holes are co-axially formed a first connection channel, the second end being embedded between the two third raised portions, each of the sixth holes and each of the third holes are co-axially formed a second connection channel;
at least one second fastening part, which is parallel to the Z-axis and has two opposite ends, a third end and a fourth end, the third end having at least one seventh hole that is parallel to the X-axis and penetrates through the third end, the fourth end having at least one eighth hole that is parallel to the X-axis and penetrates through the fourth end, the second fastening part being disposed on the second surface of the fuel cell stack, the third end being embedded between the two second raised portions, each of the seventh holes and each of the second holes being co-axially formed a third connection channel, the fourth end being embedded between the two fourth raised portions, each of the eighth holes and each of the fourth holes being co-axially formed a fourth connection channel; and
a plurality of connection assemblies, which are disposed at the first connection channel, the second connection channel, the third connection channel, and the fourth connection channel respectively.

2. The clamping apparatus for the fuel cell stack according to claim 1, wherein a shape of the first pressing part is the same as a shape of the second pressing part.

3. The clamping apparatus for the fuel cell stack according to claim 1, wherein a shape of the first fastening part is the same as a shape of the second fastening part.

4. The clamping apparatus for the fuel cell stack according to claim 1, wherein at least one elastic member is disposed between the first pressing part and the top surface, the elastic member having elastic flexibility that is parallel to the Z-axis.

5. The clamping apparatus for the fuel cell stack according to claim 4, wherein the elastic member is selected from the group consisting of: disc-shaped spring, and cushioning pad made of rubber, silicone, and foam metal.

6. The clamping apparatus for the fuel cell stack according to claim 4, wherein a bottom surface of the first pressing part and the top surface of the fuel cell stack are faced to each other, at least one first recess portion being disposed on the top surface of the fuel cell stack, a second recess portion being disposed on the bottom surface of the first pressing part, wherein the second recess portion corresponds to the first recess portion, the elastic member being disposed between the first recess portion and the second recess portion.

7. The clamping apparatus for the fuel cell stack according to claim 6, wherein a screw hole is disposed at the first pressing part and corresponds to the second recess portion, the screw hole being parallel to the Z-axis and penetrating through the first pressing part, a bolt being disposed in the screw hole and parallel to the Z-axis, the bolt being screwed into the screw hole from outside of the first pressing part and penetrating through the elastic member to the first recess portion that corresponds to the elastic member, a distance between the first pressing part and the top surface being adjusted via the bolt and the elastic member.

8. The clamping apparatus for the fuel cell stack according to claim 1, wherein cross-sections of the first fastening part and the second fastening part are regular or irregular geometric shapes, the two cross-sections being parallel to the X-Y plane.

9. The clamping apparatus for the fuel cell stack according to claim 1, wherein materials of the first pressing part, the second pressing part, the first fastening part, and the second fastening part are selected from the group consisting of: steel, aluminum, plastic steel, and plastic.

10. The clamping apparatus for the fuel cell stack according to claim 1, wherein the connection assembly has a bolt and a nut, the first connection channel, the second connection channel, the third connection channel, and the fourth connection channel are fastened by the bolt and the nut respectively.

11. A clamping apparatus for a fuel cell stack, the fuel cell stack having a top surface and a bottom surface, the clamping apparatus comprising:
at least one first pressing part, which one side has a plurality of first raised portions, each of the first raised portions having a first hole that penetrates through the first raised portion, the first pressing part being disposed on the top surface of the fuel cell stack;
at least one second pressing part, disposed on the bottom surface of the fuel cell stack;
at least one first fastening part, having a first end and a second end that are opposite to each other, the first end having at least one second hole that penetrates through the first end, the second end being connected with the second pressing part, the first end being embedded between the two first raised portions, the second hole and each of the first hole forming a first connection channel; and
at least one first connection assembly, penetrating through the first connection channel.

12. The clamping apparatus for the fuel cell stack according to claim 11, wherein the first connection assembly has a bolt and a nut, the bolt penetrating through the first connection channel and screwing together with the nut.

13. The clamping apparatus for the fuel cell stack according to claim 11, wherein a cross-section of the first fastening part is a regular or irregular geometric shape; and
the first hole and the second hole being conformal with the cross-section of the first fastening part.

14. The clamping apparatus for the fuel cell stack according to claim 11, wherein one side of the second pressing part has a plurality of second raised portions, each of the second raised portions having a third hole that penetrates through the second raised portion, the second end of the first fastening part having at least one fourth hole that penetrates through the second end, the second end being embedded between the two second raised portions, the fourth hole and each of the third hole forming a second connection channel; and
the clamping apparatus for the fuel cell stack further comprising at least one second connection assembly that penetrates through the second connection channel.
